(19) United States
(12) Patent Application Publication
(10) Pub. No.: US 2006/0180674 A1
(43) Pub. Date: Aug. 17, 2006

(54) Security card apparatus

(75) Inventors: Yanki Margalit, Ramat-Gan (IL); Dany Margalit, Ramat-Gan (IL)

Correspondence Address: DR.. MARK FRIEDMAN LTD.;C/o Bill Polkinghorn, 9003 Florin Way, Upper Marlboro, MD, 20772, US

(73) Assignee: Aladdin Knowledge Systems Ltd.

(21) Appl. No.: 11/134,410

(22) Filed: May 23, 2005

(30) Foreign Application Priority Data
Feb. 14, 2005 (IL) 166860

(51) Int. Cl. G06K 19/06

(52) U.S. Cl. 235/492

(57) ABSTRACT

The present invention is directed to a security card apparatus, comprising: electronic circuitry, e.g. smart card chip, flash memory, CPU, and memory, for providing a service to a host; a common computer communication interface, for connecting the security card apparatus to the host; a substrate of about a typical business card form, on which the circuitry and the communication interface are embedded. The substrate may comprise an out-standing part on which contacts of the common computer communication interface are embedded, thereby allowing the apparatus to be connected to a corresponding connector of the host. The apparatus may further comprise a biometric sensor such as a fingerprint reader for sampling a fingerprint of a user for authenticating the user.

### FIELD OF THE INVENTION

The present invention relates to the fields of business/credit cards and security tokens.

### BACKGROUND OF THE INVENTION

The term Portable Device refers herein as to a small device, which connects to a host via a common computer interface such as USB and FireWire, and typically used for carrying out functionalities of personal nature in conjunction with the host it connects to. Due to its small size, a portable device is easy to be carried by a user. Because of its portability, it typically is used for activities of personal nature such as authentication and electronic wallet. Security tokens like Aladdin's eToken™, RSA's SecurID™ and Rainbow's iKey™, are portable devices. Generally, they provide security related functionalities such as encryption, decryption, secure storage, identification, etc. Portable Flash memory such as M-System's Disk-On-Key™ is also a portable device.

One of the drawbacks of existing portable devices is its small size, due which it cannot accommodate a picture of its owner, a comfortable keyboard for inputting data, a fingerprint reader, or any other feature that requires wider area.

Another drawback of existing portable devices is that they are perceived as relating to a key fob more than with a credit card, which results in marketing obstacles.

The term Security Card Apparatus (SCA) refers herein to a device of about a credit card size or business card size, which employs electronic circuitry for performing activities of personal nature, and communicates with a host. A smart card is an example of an SCA.

Currently smart cards are designed to communicate with a host via a smart card reader. Although currently the use of smart cards is common, computers are rarely coupled with an interface to a smart card. Another way for communicating between a SCA and a host is by incorporating a display in the SCA, and enabling the user to type the content of the display on a keyboard of the host. This method is common in one-time-password applications. Due to the limited ways of communicating between a SCA and a host, SCAs are not common in authentication and security related activities.

It is an object of the present invention to provide a security card apparatus, which can be used for authentication and security related issues more efficiently than in the prior art.

It is another object of the present invention to provide a security card apparatus, which connects to a computer by a common computer interface.

It is a further object of the present invention to provide a portable device in a form factor of a credit card/smart card.

Other objects and advantages of the invention will become apparent as the description proceeds.

### SUMMARY OF THE INVENTION

The present invention is directed to a security card apparatus, comprising:
electronic circuitry, e.g. smart card chip, flash memory, CPU, and memory, for providing a service to a host;
a common (i.e. most widely known) computer communication interface, for connecting the security card apparatus to the host;
a substrate of a typical business card form, on which the electronic circuitry and the communication interface are embedded.

The common communication interface may be of wired communication interface e.g. USB, FireWire, RS232, parallel communication interface, serial communication interface, or wireless communication interface e.g. Radio Frequency communication, infrared communication, Bluetooth protocol, IrDA protocol, proximity card protocol, and so forth.

The apparatus may further comprise a biometric sensor (e.g. fingerprint reader), for sampling biometric information of a user, in order to authenticate the user.

The term Out-standing Part refers herein to a part which stands out or protrudes from the typical form substrate.

The substrate may comprise a part which stands out or protrudes from a typical form of the substrate, and on which contacts of the common computer communication interface are embedded, thereby allowing the apparatus to be connected to a corresponding connector of the host.

According to one embodiment of the invention, the out-standing part stands out or protrudes from the typical business card form.

According to another embodiment of the invention, the out-standing part is obtained by “removing” part(s) of the business card typical size.

According to yet another embodiment of the invention, the out-standing part is pulled out from the substrate.

The outstanding part may be located on an edge of the typical business card form, on a corner of the typical business card form, etc.

According to one embodiment of the invention, an adapter connects the common computer communication interface of the host to the apparatus. The adapter may further comprise an extension cord.

### BRIEF DESCRIPTION OF THE FIGURES

The present invention may be better understood in conjunction with the following figures:

FIG. 1 schematically illustrates a security card apparatus, according to a preferred embodiment of the invention.

FIG. 2 illustrates a USB connector, according to the prior art.

FIG. 3a schematically illustrates connecting elements of a USB interface, according to the prior art.

FIG. 4 schematically illustrates the connecting elements of a USB interface, according to a preferred embodiment of the invention.

FIG. 5a illustrates a smart card, according to one embodiment of the invention.

FIG. 5b illustrates the smart card of FIG. 5a, after removing part(s) 60.

FIG. 6 illustrates a smart card, according to another embodiment of the invention.

FIG. 7 illustrates a security card apparatus, according to yet another embodiment of the invention.

FIGS. 8a and 8b schematically illustrates a security card apparatus, according to still another embodiment of the invention.

FIG. 9 schematically illustrates a security card apparatus, according to still another embodiment of the invention.

FIG. 10 schematically illustrates a security card apparatus, according to still another embodiment of the invention.

FIG. 11a and 11b schematically illustrate a system for connecting a security card apparatus to a host, according to still another embodiment of the invention.

FIG. 12 schematically illustrate a system for connecting a security card apparatus to a host, according to still another embodiment if the invention.

FIG. 13 schematically illustrates a security card apparatus, according to still another embodiment of the invention.

FIG. 14 schematically illustrates a security card apparatus, according to still another embodiment of the invention.

### DETAILED DESCRIPTION OF PREFERRED EMBODIMENTS

FireWire is Apple Computer's version of the IEEE 1394 standard, for connecting a device to a personal computer. The standard defines a serial bus or pathway between one or more peripheral devices and a computer's microprocessor. IEEE 1394 implementations were expected to replace and consolidate serial and parallel interfaces, including Centronics parallel, RS-232C, and Small Computer System Interface (SCSI).

USB (Universal Serial Bus) is a plug-and-play interface between a computer and peripheral devices, such as scanners, printers, digital cameras, etc. Today, most new computers and peripheral devices support the USB interface.

The term Smart Card refers herein to a card about the size of a credit card, typically made of plastic, in which a microchip (also referred herein as Smart Card Chip) is embedded.

Typically a smart card chip comprises non-volatile memory and a CPU. Therefore, a smart card chip is actually a computer. The chip is designed such that an unauthorized person or object has to use a tremendous effort to disclose its content (including the content of the non-volatile memory) and/or structure. Therefore, a smart card chip can be considered as a secured facility.

Today smart cards are designed according to standards/common specifications thereof, e.g. ISO7816, and employ dedicated operating systems, such as MULTOS.

A significant drawback of a smart card is that it can be connected to a host only via a smart card reader, whilst the personal computers distributed currently on the market usually do not comprise smart card readers. As a result, the use of smart cards doesn't reach to its potential. The present invention takes a few steps forward, and makes a connection between a smart card device and common computer interface, whether the interface is a wired or wireless.

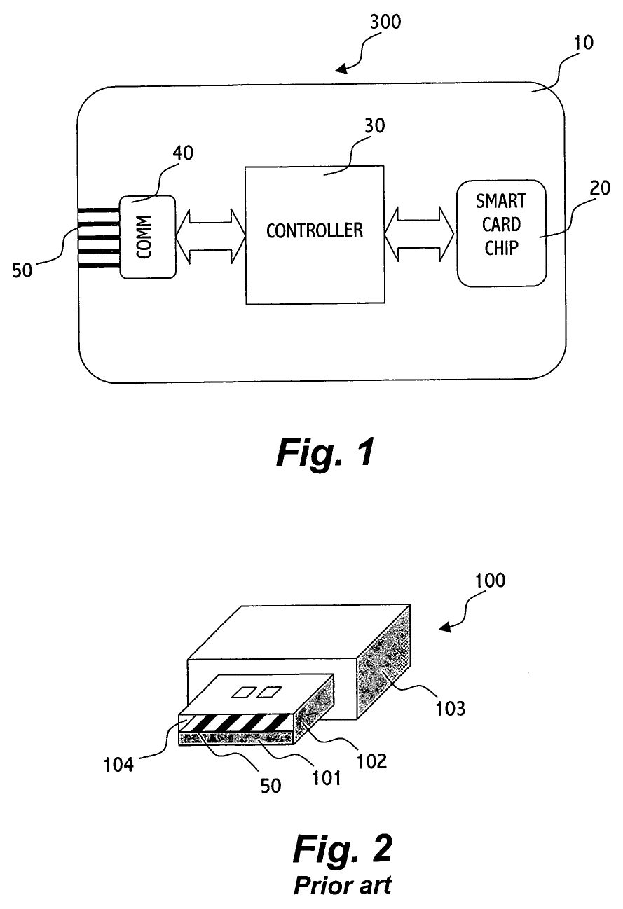

FIG. 1 schematically illustrates a security card apparatus, according to a preferred embodiment of the invention. The security card apparatus 300 comprises a substrate 10, upon which the rest of the parts of the apparatus are placed; a smart card chip 20, for rendering smart card functionality; a computer communication interface 40 (e.g. USB), for connecting the smart card chip 20 to a computer (not shown), and a controller 30, through which the smart card chip 20 connects to communication interface 40. The physical contact between the security card apparatus and a computer is carried out by the conductive contacts 50. Typically the dimensions of substrate 10 comply with the ISO/IEC 7810:2003 standard.

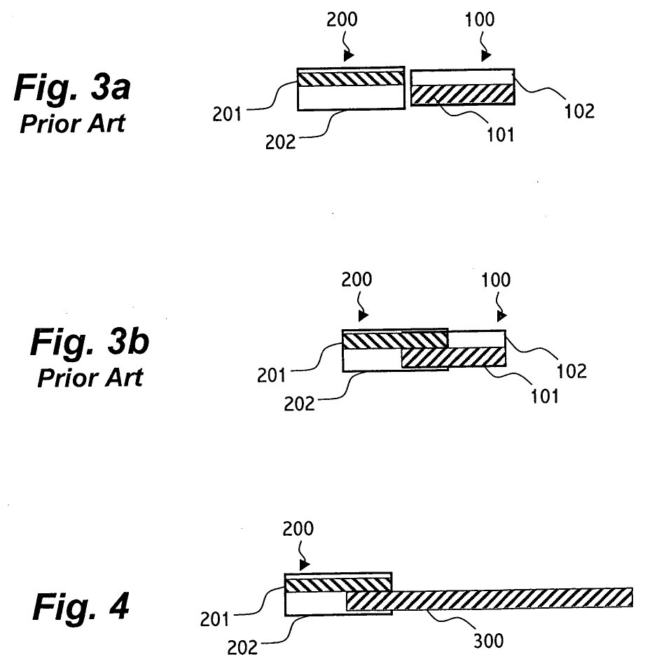

One advantage of the solution presented in FIG. 1 is that it has a business or credit card form. On the other hand it is not possible to plug it into a common USB connector since the physical form of the case of the USB connector (e.g. element 202 of FIG. 3a) prevents the connection. This can be solved by modifying the USB connector accordingly, as will be explained hereinafter.

FIG. 2 illustrates a USB connector 100, according to the prior art. A case 102 comprises at its lower side a non-conductive substrate 101, on which conductive contacts 50 are “printed”. A gap 104 separates between the substrate 101 and the case 102. Upon plugging USB connector 100 into a connecting socket of a host (e.g. a computer, digital camera, etc.), the contacts 50 create a contact with corresponding contacts of the host (not shown in FIG. 2 but illustrated on FIGS. 3a, 3b and 4).

FIG. 3a schematically illustrates connecting elements of a USB interface, according to the prior art. The first connecting device 100 comprises a case 102 and a substrate 101 on which the contacts (not shown) are printed. The second connecting device 200 comprises a case 202 and a substrate 201 on which the contacts (not shown) are printed.

FIG. 3b schematically illustrates the connecting elements FIG. 3a, on contact.

FIG. 4 schematically illustrates the connecting elements of a USB interface, according to a preferred embodiment of the invention. The smart card 300 plugs into a connecting device 200. With reference to FIGS. 2a and 2b, the smart card 300 replaces substrate 101 of FIGS. 2a and 2b, and case 102 is not used, thereby maintaining the flat form of the smart card 300.

According to a preferred embodiment of the invention, in order to connect a smart card device to a “standard” interface, e.g. USB and FireWire, part(s) of the smart card body are “removed” such that the remaining contour fits a connecting element of the interface. Of course the smart card may be manufactured such that these parts are missing. The contacts are placed on the connecting part of the smart card.

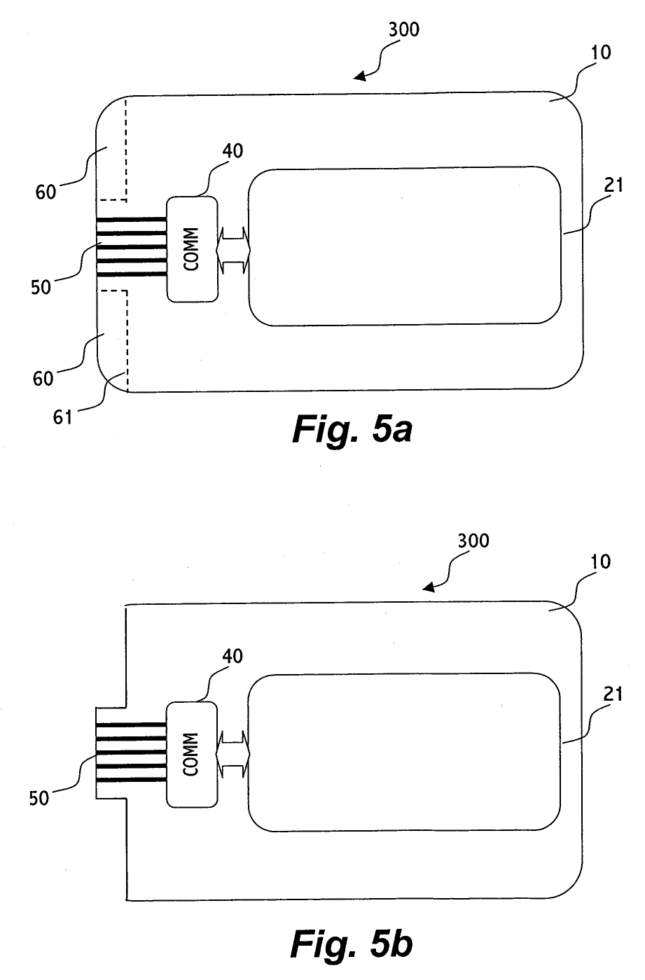

FIG. 5a illustrates a security card apparatus, according to one embodiment of the invention. From the functional point of view, SCA 300 comprises electronic circuitry 21 (e.g. smart card chip, flash chip, etc.), and a common computer communication interface 40, which connects the SCA 300 to a host (not shown in this figure) via contacts 50. From the mechanical point of view, the perforation lines 61 enable a user to remove a part 60 of the SCA. FIG. 5b illustrates the SCA of FIG. 5a, after removing parts 60. This form of the SCA corresponds to the connecting element 101 of FIGS. 3a and 3b, thereby allowing the SCA to be plugged into the corresponding connector of the USB interface (e.g. 200 in FIGS. 3a and 3b). Of course instead of removing of parts 60 from the SCA 300, the SCA can be manufactured such that part(s) 60 are missing.

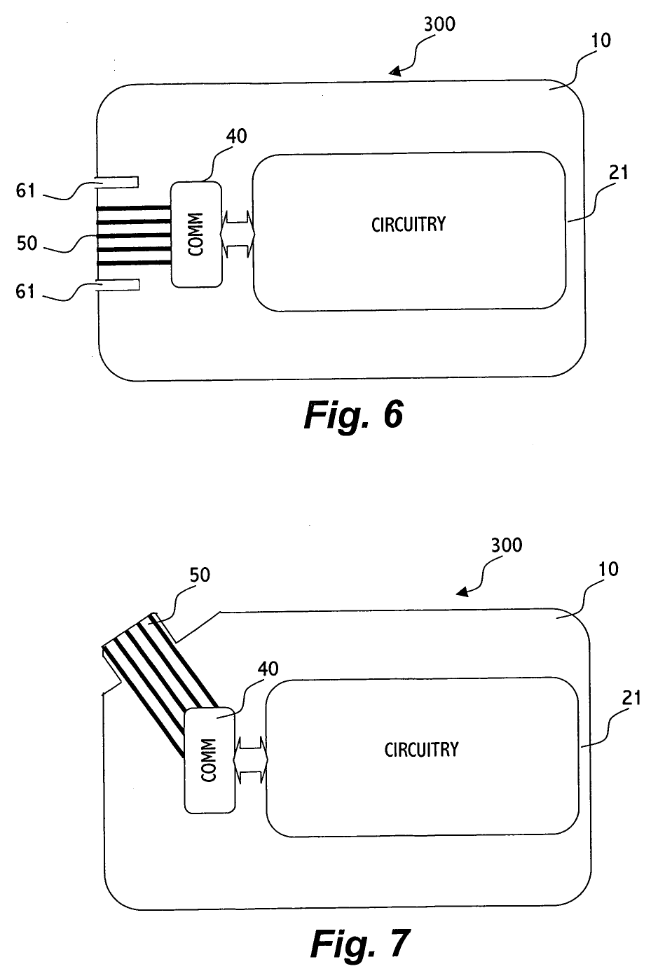

FIG. 6 illustrates a smart card, according to another embodiment of the invention. The removed parts 61 correspond to case 202 of FIG. 4. The advantage of this solution is that the typical form of a business card is maintained, but on the other hand it may require some changes on the other connecting party, in order to enable the physical connection.

FIG. 7 illustrates a security card apparatus, according to yet another embodiment of the invention. The removed parts 61 correspond to case 202 of FIG. 4. The advantage of this form is that the connecting element on which the contacts 50 are printed is placed on a corner of the smart card platform 10. This form achieves two significant advantages: the contour of the platform 10 differs from a business card form slightly, and no modification is required on the connector to which the smart card 300 is to be connected to.

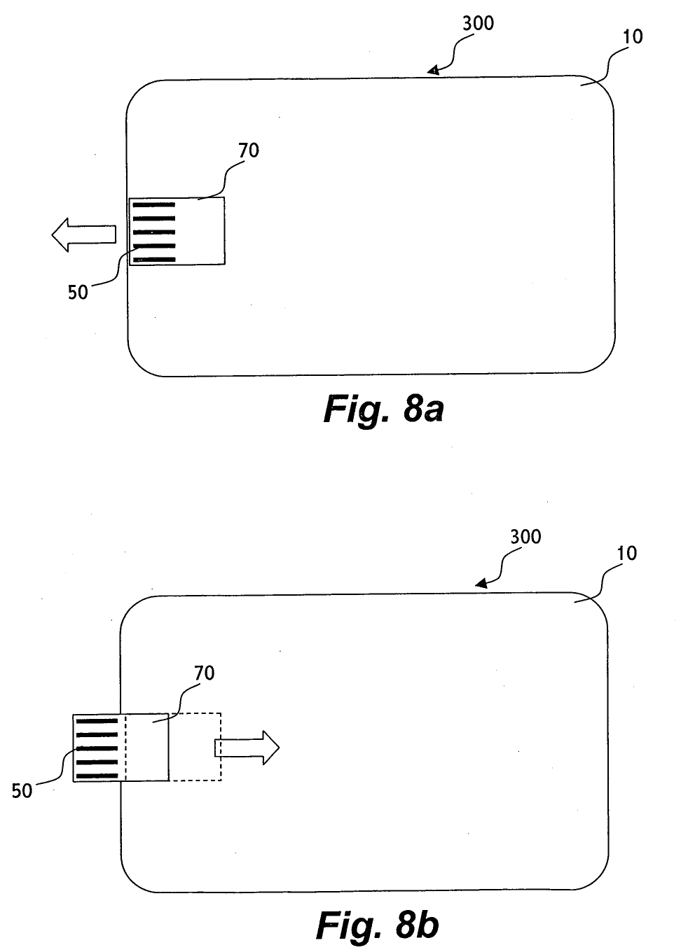

FIGS. 8a and 8b schematically illustrates a security card apparatus, according to still another embodiment of the invention. The contacts 50 are placed on a moving element 70, which can be pulled out in such a way that the contacts 50 will be placed outside the contour of the security card apparatus 300, thereby enabling it to be plugged into a USB connector. On the one hand the benefit of this form is that it complies to a business card form, however on the other hand due to the common thickness of a business card, such a solution requires mechanical modifications, such as using a more rigid material for the business card substrate 10, and the substrate may be thicker than the common thickness used for business cards, to accommodate, for example, a rigid “rail” on which the moving element 70 moves, etc.

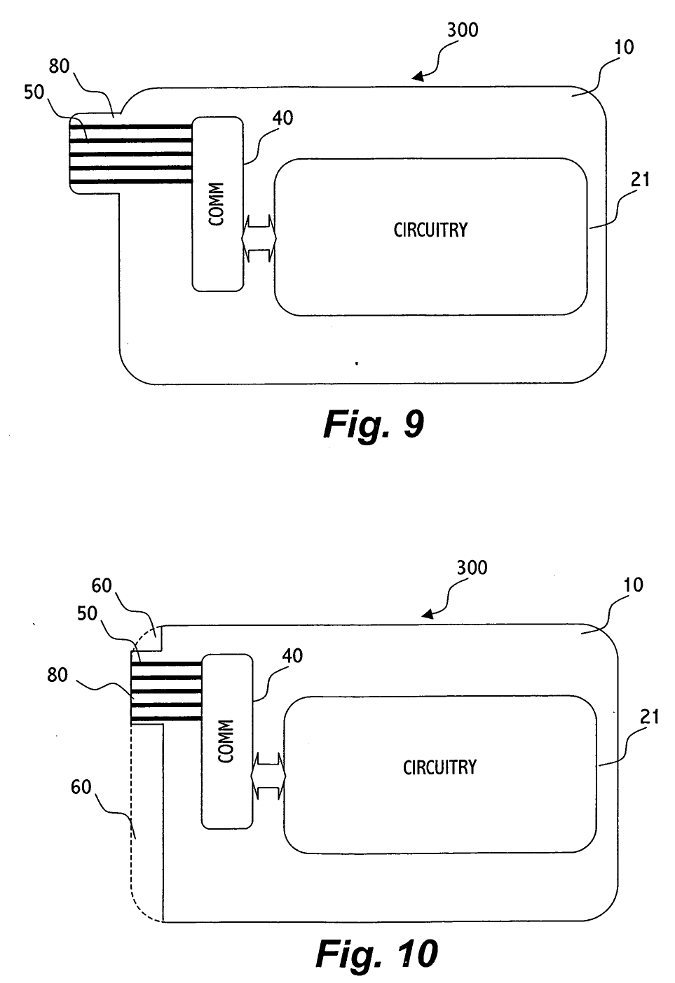

FIG. 9 schematically illustrates a security card apparatus, according to still another embodiment of the invention. According to this embodiment, the typical business card form is slightly changed by adding an element 80, which stands out slightly from the card on which the contacts 50 are placed. This way the security card apparatus 300 can be plugged into a corresponding connector of a host (not shown) without modifying the corresponding connector of the host. The disadvantage of this form is that element 80 stands out from the typical business card form of security card apparatus 300, and therefore this embodiment may not be suitable for a wallet which is designed to store business cards.

FIG. 10 schematically illustrates a security card apparatus, according to still another embodiment of the invention. According to this embodiment, element 80 which “stands out” from the business card 10 contour is achieved as a result of removing parts 60 from the security card apparatus 300. As a result the security card apparatus 300 of FIG. 10 fits a wallet designed to store business cards.

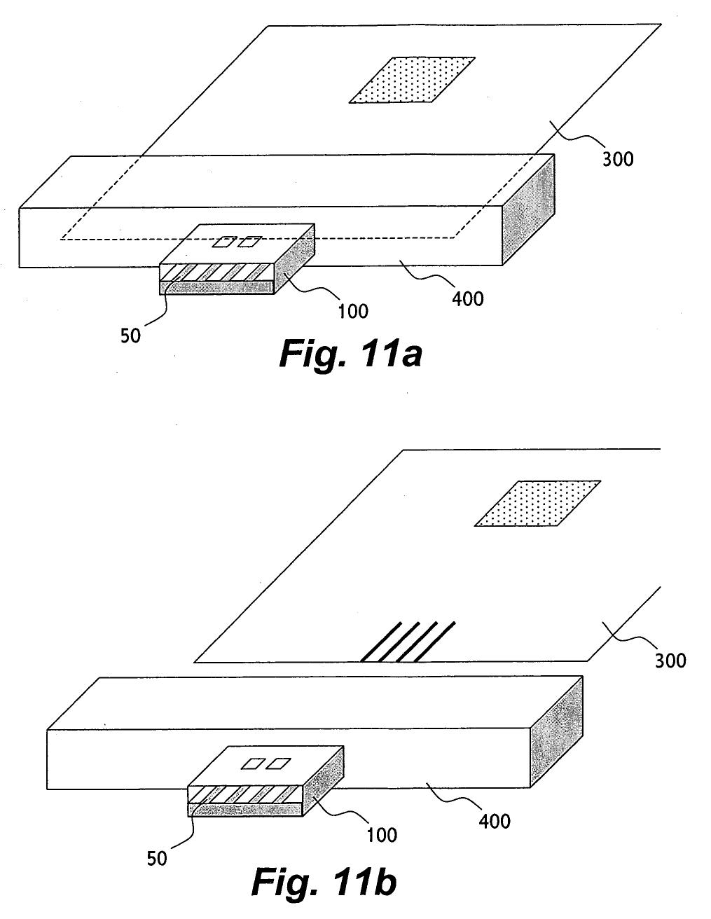

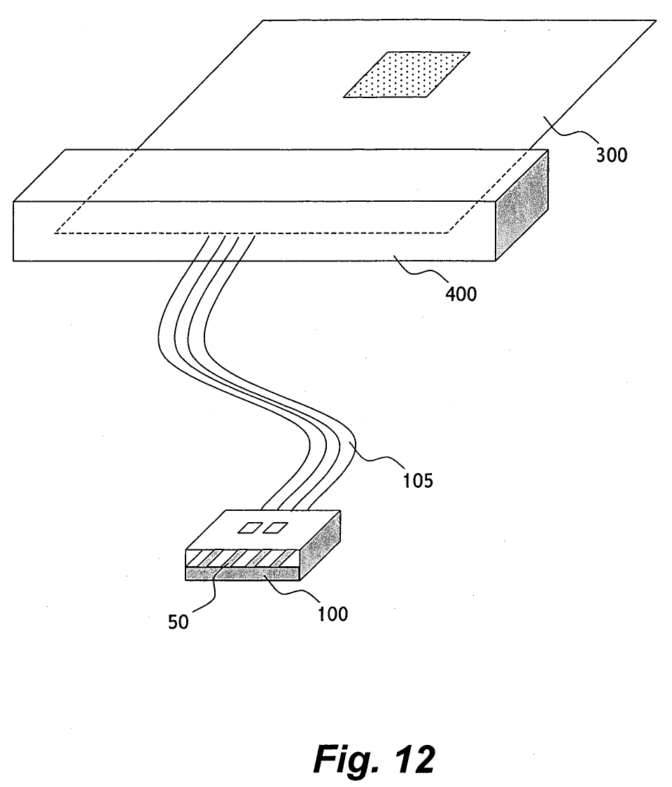

FIG. 11a and 11b schematically illustrate a system for connecting a security card apparatus to a host, according to still another embodiment of the invention. According to this embodiment, an adapter 400 connects between a USB connector 100 and a security card apparatus 300. The USB connector 100 may be connected to connector 400 directly or via an extension cord 105, as illustrated in FIG. 12. Connector 400 has a slot into which the security card apparatus 300 is to be plugged. It should be noted that the connecting device 400 may comprise only wires, since no data conversion or any other manipulation of the data is required in this adapter. Using an adapter between the common computer communication interface and the host provides flexibility of the solutions for connecting said elements. Typically, on one side of the adapter there is a connector that complies with the protocol of the common computer communication interface, and on the other side the designer is free to design any solution.

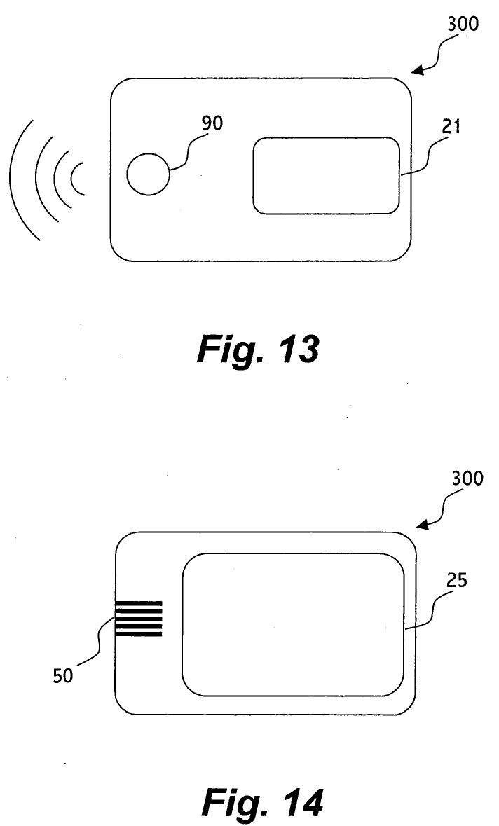

FIG. 13 schematically illustrates a security card apparatus, according to still another embodiment of the invention. A wireless communication means 90 communicates with a host (not shown) via wireless communication protocol, such as Bluetooth, IrDA, etc.

FIG. 14 schematically illustrates a security card apparatus, according to still another embodiment of the invention. According to this embodiment the security card apparatus 300 is coupled to a fingerprint reader 25, by which the fingerprint of the business card user can be obtained and used for authenticating the user prior to providing to the user further services. The authentication can be carried out by the circuitry of the business card, the host, or by the circuitries of both the host and the business card.

Those skilled in the art will appreciate that the invention can be embodied by other forms and ways, without losing the scope of the invention. The embodiments described herein should be considered as illustrative and not restrictive.

1. A security card apparatus, comprising:
electronic circuitry, for providing a service to a host;
a common computer communication interface, for connecting said electronic circuitry to said host;
a substrate of a typical business card form, in which said electronic circuitry and said communication interface are embedded.

2. An apparatus according to claim 1, wherein said common communication interface is selected from a group comprising: wired communication interface, wireless communication interface.

3. An apparatus according to claim 2, wherein said wired communication interface is selected from a group comprising: USB, FireWire, RS232, parallel communication interface, serial communication interface.

4. An apparatus according to claim 2, wherein said wireless communication interface is selected from a group comprising: Radio Frequency communication interface, infrared communication interface, Bluetooth protocol interface, IrDA protocol interface, proximity card protocol interface.

5. An apparatus according to claim 1, further comprising a biometric sensor, for sampling biometric information of a user for authenticating said user.

6. An apparatus according to claim 5, wherein said biometric sensor is a fingerprint reader.

7. An apparatus according to claim 1, wherein said electronic circuitry comprises an element selected from a group comprising: smart card chip, flash memory, CPU, memory

8. An apparatus according to claim 1, wherein said substrate comprises an out-standing part on which contacts of said common computer communication interface are embedded, thereby allowing said apparatus to be connected to a corresponding connector of said host.

9. An apparatus according to claim 8, wherein said out-standing part stands out from a business card form.

10. An apparatus according to claim 8, wherein said out-standing part is obtained by removing at least one part of said business card form.

11. An apparatus according to claim 8, wherein said out-standing part is adapted to be reversibly pulled out from said substrate.

12. An apparatus according to claim 8, wherein said out-standing part is located on an edge of said business card form.

13. An apparatus according to claim 8, wherein said out-standing part is located on a corner of said business card form.

14. An apparatus according to claim 1, further comprising an adapter for connecting said common computer communication interface of said host to the communication interface of said computer.

15. An apparatus according to claim 14, wherein said adapter comprises an extension cord.
